(19) United States
(12) Patent Application Publication
(10) Pub. No.: US 2006/0044074 A1
(43) Pub. Date: Mar. 2, 2006

(54) High-directivity spurline directional coupler

(76) Inventors: Sheng-Fuh Chang, Chiayi (TW); Jia-Liang Chen, Chiayi (TW); Chuan-Ting Wu, Chiayi (TW); Juo-Rui Tsai, Chiayi (TW); Zong-Hsian Tsai, Chia-Yi (TW); Hung-Cheng Chen, Hsinchu (TW); Shu-Fen Tang, Hsinchu (TW); Albert Chen, Hsinchu (TW)

Correspondence Address: BIRCH STEWART KOLASCH & BIRCH, PO BOX 747, FALLS CHURCH, VA, 22040-0747, US

(21) Appl. No.: 10/932,086

(22) Filed: Sep. 2, 2004

(51) Int. Cl. H01P 5/18

(52) U.S. Cl. 333/116

(57) ABSTRACT

A spurline directional coupler includes a first coupling section and a second coupling section that are in parallel with each other for coupling, and a first sub-coupling section and a second sub-coupling section coupled with the first coupling section, and a third sub-coupling section and a fourth sub-coupling section coupled with the second coupling section. The parallel coupling relationship between the coupling section and the sub-coupling sections generates a capacitive effect thereby may improve isolation and directivity of the spurline directional coupler.

### FIELD OF THE INVENTION

The present invention relates to a coupler and particularly to a spurline directional coupler that uses transmission lines to generate a capacitive compensation effect to improve the directivity of the coupler.

### BACKGROUND OF THE INVENTION

A directional coupler is a widely-used element in microwave circuits such as a phase shifter, balanced amplifier, balanced mixer, power divider, modulator, power detector and the like. Particularly in microwave integrated circuits (MIC), microstrip parallel-coupled lines are commonly used to implement the directional coupler. They are required to have up-to −3 dB coupling amount and more than 40-dB isolation, that is, they must have high directivity.

Because of manufacturing constraints in minimum line spacing, the coupling amount of a single microstrip parallel coupler provided in the prior art is about −10 dB. To increase the coupling amount, a multi-section, multi-figure or multi-layer structure has to be adopted and the coupling amount can be increased to about −3 dB.

Another problem is that the isolation is deteriorated as frequency increases. For example, the isolation is only −20 dB at 2 GHz for a typical microstrip parallel-line coupler. The deteriorated isolation is due to the inhomogeneous microstrip structure, where a dielectric layer is inserted in air and the conductor strip is layout on one surface of the dielectric layer with another surface electrically grounded. As a result, the phase velocities of the odd mode and even mode, which are two characteristic modes of the microstrip parallel-line coupler, are different.

Various techniques have been reported to enhance the directivity. These include adding a different dielectric overlay on top of coupled lines. Another method wiggles the inner edges of coupled lines. Still another method is to add reactive lumped elements at the ends or the center of coupled lines. These techniques have drawbacks of either departing away from the planar structure due to the addition of lump elements, or requiring special fabrication procedures for another dielectric overlay or wiggling the conductor edges.

### SUMMARY OF THE INVENTION

In view of the problems set forth above, the primary object of the invention is to provide a spurline directional coupler that adds respectively a spur-like sub-coupler on two ends of the primary coupler in a symmetrical or asymmetrical manner. By controlling the length and the spacing of the sub-coupler, an isolation zero can be generated in the desired frequency band, thereby improving the directivity of the coupler.

In order to achieve the forgoing object, the spurline directional coupler according to the invention includes a first coupling section with two ends connected respectively to a first signal transmission section and a second signal transmission section, a second coupling section with two ends connected respectively to a third signal transmission section and a fourth signal transmission section, a first sub-coupling section which has one end connected to the first signal transmission section with another end open-circuited, a second sub-coupling section which has one end connected to the second signal transmission section with another end open-circuited, a third sub-coupling section which has one end connected to the third signal transmission section with another end open-circuited, and a fourth sub-coupling section which has one end connected to the fourth signal transmission section with another end open-circuited. The second coupling section is substantially in parallel with the first coupling section to provide the coupling amount. The first sub-coupling section and the second sub-coupling section are substantially in parallel with the first coupling section for coupling, to generate a capacitive effect with the first coupling section. The third sub-coupling section and the fourth sub-coupling section are substantially in parallel with the second coupling section for coupling, to generate another capacitive effect with the second coupling section.

The isolation of the typical parallel coupler deteriorates as frequency increases. The coupler of the invention can generate an isolation zero in the desired frequency to improve the directivity due to the capacitive effects of sub-coupling sections.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the edge-coupling structure of the spurline directional coupler according to the invention.

FIG. 2 is broadside-coupling structure of the spurline directional coupler according to the invention.

FIGS. 3A, 3B and 3C are equivalent models of the spurline directional coupler according to the invention.

FIG. 4 is an equivalent model of the spurline directional coupler according to the invention.

FIG. 5 is the simulation transmission of the spurline directional coupler according to the invention.

FIG. 6 is the simulation coupling amount of the spurline directional coupler according to the invention.

FIG. 7 is simulation isolation of the spurline directional coupler according to the invention.

FIG. 8 is the simulation directivity of the spurline directional coupler according to the invention.

FIG. 9 is the measured transmission of the spurline directional coupler according to the invention.

FIG. 10 is the measured coupling amount of the spurline directional coupler according to the invention.

FIG. 11 is the measured isolation of the spurline directional coupler according to the invention.

FIG. 12 is the measured directivity of the spurline directional according to the invention.

### DESCRIPTION OF THE PREFERRED EMBODIMENTS

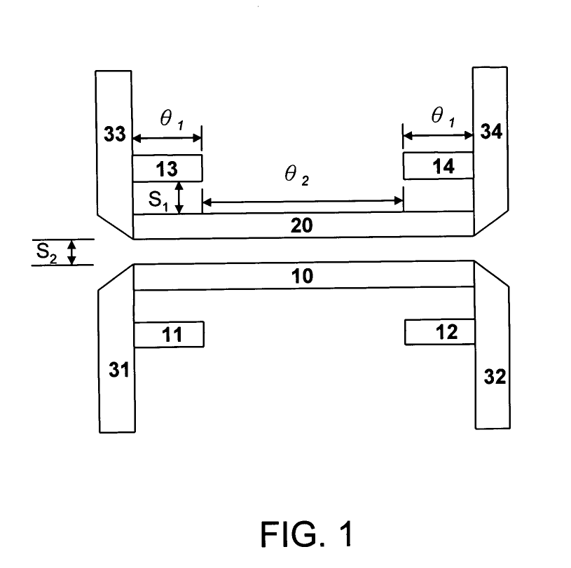

The spurline directional coupler according to the invention aims to generate high directivity. Referring to FIG. 1, it includes a primary coupling section and a sub-coupling section. The primary coupling section includes a first coupling section 10 and a second coupling section 20. The sub-coupling section includes a first sub-coupling section 11, a second sub-coupling section 12, a third sub-coupling section 13, and a fourth sub-coupling section 14.

The first coupling section 10 has one end connected to a first signal transmission section 31 and another end connected to a second signal transmission section 32. The second coupling section 20 has one end connected to a third signal transmission section 33 and another end connected to a fourth signal transmission section 34. The second coupling section 20 is substantially in parallel with the first coupling section 10. They are not in contact with each other to form a parallel coupling.

The first sub-coupling section 11 has one end connected to the first signal transmission section 31 with another end open-circuited. The second sub-coupling section 12 has one end connected to the second signal transmission section 32 with another end open-circuited. The first sub-coupling section 11 and the second sub-coupling section 12 are located on the same side of the first coupling section 10, and are substantially in parallel with the first coupling section 10 for coupling.

The third sub-coupling section 13 has one end connected to the third signal transmission section 33 with another end open-circuited. The fourth sub-coupling section 14 has one end connected to the fourth signal transmission section 34 with another end open-circuited. The third sub-coupling section 13 and the fourth sub-coupling section 14 are located on the same side of the second coupling section 20, and are substantially in parallel with the second coupling section 20 for coupling.

The first coupling section 10, first sub-coupling section 11, second sub-coupling section 12, first signal transmission section 31 and second signal transmission section 32 are symmetrical to the second coupling section 20, third sub-coupling section 13, fourth sub-coupling section 14, third signal transmission section 33 and fourth signal transmission section 34.

Referring to FIG. 1, all elements in the structure are TEM transmission lines or Quasi-TEM transmission lines. The first coupling section and the second coupling section are broadside-coupled in multilayer structure or single layer structure. The sub-coupling sections are formed like shoe spurs, hence the whole structure is named as spurline directional coupler.

Design of the coupler has to consider the electric length of coupling sections and the spacing between coupling sections. Referring to FIG. 1, there are two sections of electric length, namely θ₁ and θ₂. θ₁ is the electric length of the sub-coupling section. θ₂ is the electric length of the primary coupling section deducting the electric lengths of the two parallel sub-coupling sections. θ₁ is the electric length to control the generation of isolation zero. Namely, when the frequency (ƒᵢₛₒ) of the isolation zero is specified, θ₁ is set to θ_{1,iso}. If the designed electric length θ₁ is smaller than θ_{1,iso}, the frequency of isolation zero will be greater than the frequency ƒᵢₛₒ. If the designed electric length θ₁ is greater than θ_{1,iso}, the frequency of isolation zero will be smaller than the center frequency ƒᵢₛₒ. A too long electric length θ₁ creates an undesirable effect, i.e. the isolation deteriorates due to excessive capacitance compensation.

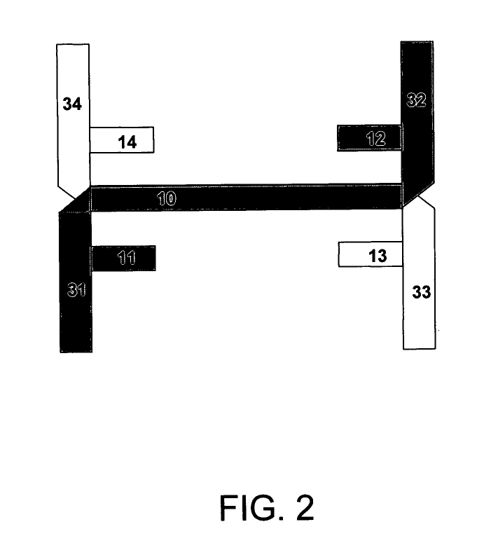

Referring to FIG. 1 and FIG. 2, once θ₁ is set, the entire electric length (θ=π/2) is the sum of 2θ₁ and θ₂ (θ=2θ₁+θ₂), therefore θ₁=π/2−2θ₁.

In addition, the spacing to be considered includes the distance S₁ between the primary coupling section and the sub-coupling section, and the distance S₂ between the primary coupling sections.

The spacing S₂ between the primary coupling sections determines the coupling amount of the entire circuit. When S₂ increases, the entire coupling amount decreases. When S₂ decreases, the entire coupling amount increases. By using different material will have a different relative dielectric constant εᵣ and thickness h, the required S₂ also is different.

The spacing S₁ between the primary coupling section and the sub-coupling section determines the equivalent capacitance effect of the first coupling section and the first sub-coupling section. Namely, it will affect the input and output return losses.

A multi-layer structure can be designed according to the required coupling amount and isolation. By referring to FIG. 2, it includes a primary coupling section and a sub-coupling section. The primary coupling section includes a first coupling section 10 and a second coupling section 20. The sub-coupling section includes a first sub-coupling section 11, a second sub-coupling section 12, a third sub-coupling section 13, and a fourth sub-coupling section 14. The first coupling section 10 and the second coupling section 20 are located on two different sides of the substrate, or in different layers of a multilayer low-temperature co-fired ceramic to form a broadside coupling.

The first coupling section 10 has one end connected to a first signal transmission section 31 and another end connected to a second signal transmission section 32. The second coupling section 20 has one end connected to a third signal transmission section 33 and another end connected to a fourth signal transmission section 34. The second coupling section 20 is substantially in parallel with the first coupling section 10.

The first sub-coupling section 11 has one end connected to the first signal transmission section 31 with another end open-circuited. The second sub-coupling section 12 has one end connected to the second signal transmission section 32 with another end open-circuited. The first sub-coupling section 11 and the second sub-coupling section 12 are located on the different side of the first coupling section 10, and are substantially in parallel with the first coupling section 10 for coupling.

The third sub-coupling section 13 has one end connected to the third signal transmission section 33 with another end open-circuited. The fourth sub-coupling section 14 has one end connected to the fourth signal transmission section 34 with another end open-circuited. The third sub-coupling section 13 and the fourth sub-coupling section 14 are located on the different side of the second coupling section 20, and are substantially in parallel with the second coupling section 20 for coupling.

The first coupling section 10, first sub-coupling section 11, second sub-coupling section 12, first signal transmission section 31 and second signal transmission section 32 are symmetric to the second coupling section 20, third sub-coupling section 13, fourth sub-coupling section 14, third signal transmission section 33 and fourth signal transmission section 34.

The reasons why the spurline directional coupler of the invention can increase the isolation and improve directivity are discussed as follows:

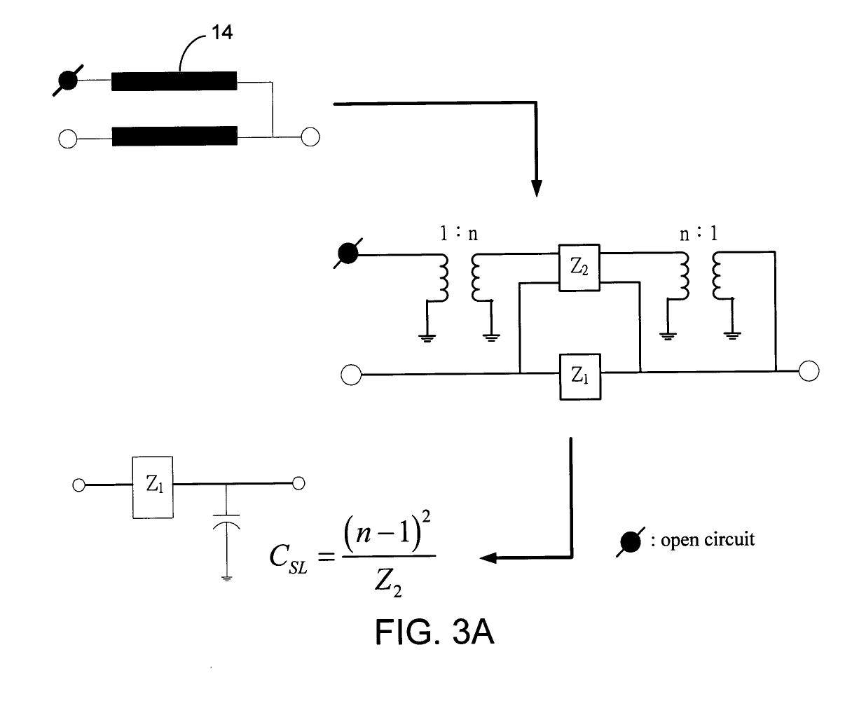

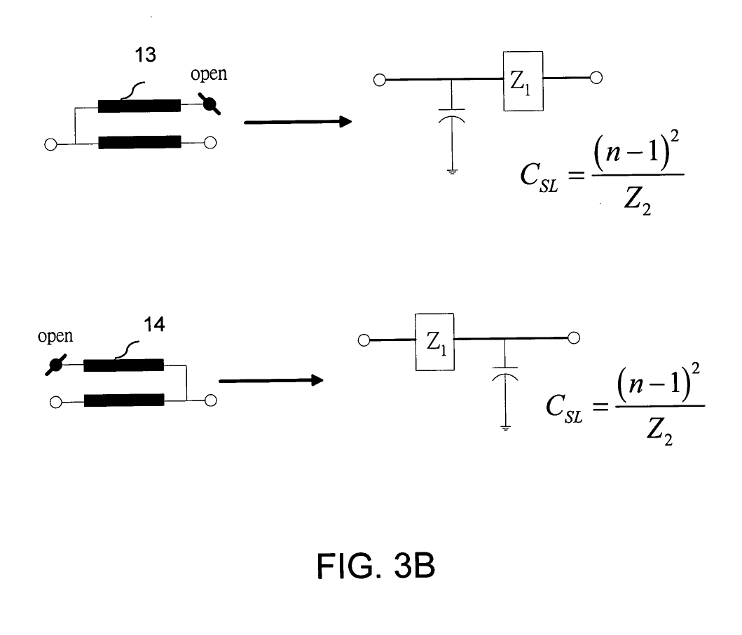

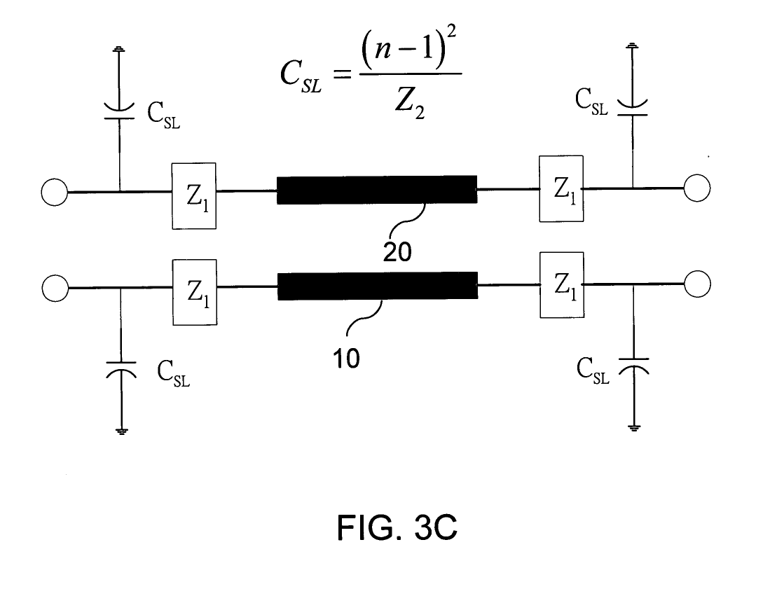

The spurline sub-coupling circuit may be modeled as a unit element (UE). Refer to FIG. 3A for a simplified model of a spurline sub-coupling circuit. It is an equivalent circuit consisting of impedance connected to a capacitor, where n=1+C₂₂/C₁₂, and C₂₂ and C₁₂ are entities of the static C matrix of a spurline sub-coupling circuit I FIG. 3A.

Based on the model shown in FIG. 3A, the sub-coupling section at two ends form an equivalent model, respectively, as shown in FIG. 3B. The equivalent model of the entire structure is shown in FIG. 3C. FIG. 3C illustrates a four-port network. Its transmission matrix can be represented in terms of the transmission matrices of the odd and even modes according to the even-odd mode theory. The odd mode, and the even mode alike, is composed of three sub-circuits, which are represented as [T]_{1SL,k}, [T]_{2MS,k}, and [T]_{3SL,k}, respectively, where ‘k’=‘e’ denotes for the even mode and ‘k’=‘o’ denotes for the odd mode. [T]_{1SL,k} represents the transmission matrix of the first spur-like sub-coupler, [T]_{2MS,k} represents the transmission matrix of the primary coupler, and [T]_{3SL,k} represents the transmission matrix of the second spur-like sub-coupler.

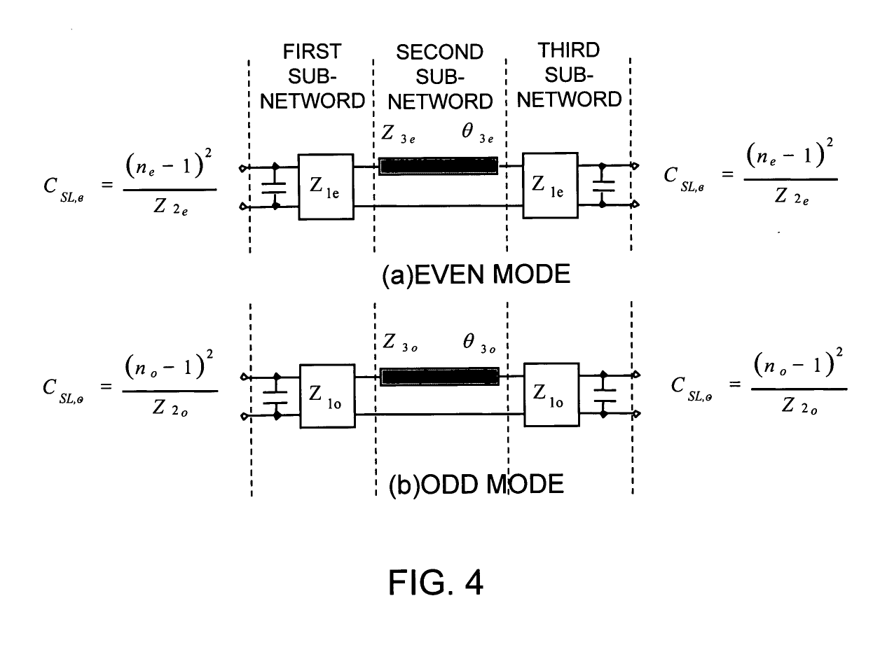

Therefore, the equivalent even mode and odd mode circuits of the spurline directional coupler are obtained in FIG. 4. [T]_{1SL,k} and [T]_{3SL,k} can be derived from FIG. 3B as follows,

$$\begin{matrix}{[ T ]}_{1 SL , k} = \frac{1}{\sqrt{1 - {( j tan {θ}_{1 k} )}^{2}}} [ \begin{matrix}1 & {Z}_{1 , k} jtan {θ}_{1 k} \\ \frac{jtan {θ}_{1 k}}{{Z}_{1 , k}} & 1\end{matrix} ] [ \begin{matrix}1 & 0 \\ j tan {θ}_{1 k} {C}_{SL , k} & 1\end{matrix} ] \\ = cos {θ}_{1 k} [ \begin{matrix}1 - {tan}^{2} {θ}_{1 k} {Z}_{1 , k} {C}_{SL , k} & j tan {θ}_{1 k} {Z}_{1 , k} \\ j tan {θ}_{1 k} ( {C}_{SL , k} + \frac{1}{{Z}_{1 , k}} ) & 1\end{matrix} ] , \\ {[ T ]}_{3 SL , k} = cos {θ}_{1 k} [ \begin{matrix}1 - {tan}^{2} {θ}_{1 k} {Z}_{1 , k} {C}_{SL , k} & j tan {θ}_{1 k} {Z}_{1 , k} \\ j tan {θ}_{1 k} ( {C}_{SL , k} + \frac{1}{{Z}_{1 , k}} ) & 1\end{matrix} ] .\end{matrix}$$

[T]_{2MS,k} represents the transmission matrix of the primary coupler, which is

$${[ T ]}_{2 MS , k} = [ \begin{matrix}A & B \\ C & D\end{matrix} ] = [ \begin{matrix}cos {θ}_{3 k} & {jZ}_{3 k} sin {θ}_{3 k} \\ {jY}_{3 k} sin {θ}_{3 k} & cos {θ}_{3 k}\end{matrix} ] .$$

With the above equations, the even-mode and odd-mode transmission matrices are obtained as

$${[ T ]}_{even} = {[ \begin{matrix}A & B \\ C & D\end{matrix} ]}_{even} = {{{{[ T ]}_{1 SL , even} [ T ]}_{MS , even} [ T ]}_{3 SL , even} \\ [ T ]}_{odd} = {[ \begin{matrix}A & B \\ C & D\end{matrix} ]}_{odd} = {{{[ T ]}_{1 SL , odd} [ T ]}_{MS , odd} [ T ]}_{3 SL , odd} .$$

Then even-mode and odd-mode scattering matrices can be derived with the following transformation

$${S}_{11}^{e , o} = \frac{{A}^{e , o} + {B}^{e , o} / {Z}_{o} - {C}^{e , o} {Z}_{o} - {D}^{e , o}}{{A}^{e , o} + {B}^{e , o} / {Z}_{o} + {C}^{e , o} {Z}_{o} + {D}^{e , o}}$$

$${S}_{12}^{e , o} = \frac{2 ( {A}^{e , o} {D}^{e , o} - {B}^{e , o} {D}^{e , o} )}{{A}^{e , o} + {B}^{e , o} / {Z}_{o} + {C}^{e , o} {Z}_{o} + {D}^{e , o}}$$

$${S}_{11}^{e , o} = \frac{2}{{A}^{e , o} + {B}^{e , o} / {Z}_{o} + {C}^{e , o} {Z}_{o} + {D}^{e , o}}$$

$${S}_{22}^{e , o} = \frac{- {A}^{e , o} + {B}^{e , o} / {Z}_{o} - {C}^{e , o} {Z}_{o} - {D}^{e , o}}{{A}^{e , o} + {B}^{e , o} / {Z}_{o} + {C}^{e , o} {Z}_{o} + {D}^{e , o}}$$

Finally, the entire spurline directional coupler can be readily obtained by

$$[ S ] = [ \begin{matrix}{S}_{11} & {S}_{12} & {S}_{13} & {S}_{14} \\ {S}_{21} & {S}_{22} & {S}_{23} & {S}_{24} \\ {S}_{31} & {S}_{32} & {S}_{33} & {S}_{34} \\ {S}_{41} & {S}_{42} & {S}_{43} & {S}_{44}\end{matrix} ]$$

$${S}_{11} = \frac{1}{2} ( {S}_{11}^{e} + {S}_{11}^{o} )$$

$${S}_{21} = \frac{1}{2} ( {S}_{21}^{e} + {S}_{21}^{o} )$$

$${S}_{31} = \frac{1}{2} ( {S}_{11}^{e} + {S}_{11}^{o} )$$

$${S}_{41} = \frac{1}{2} ( {S}_{21}^{e} + {S}_{21}^{o} )$$

If the condition making S₄₁=0 exists, an isolation zero is generated, which means the unequal phase velocities of even and odd modes are equalized by the spurline sub-coupler in the invention.

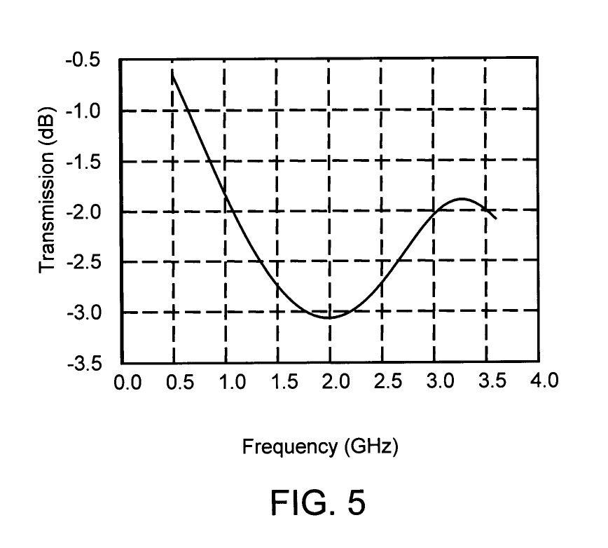

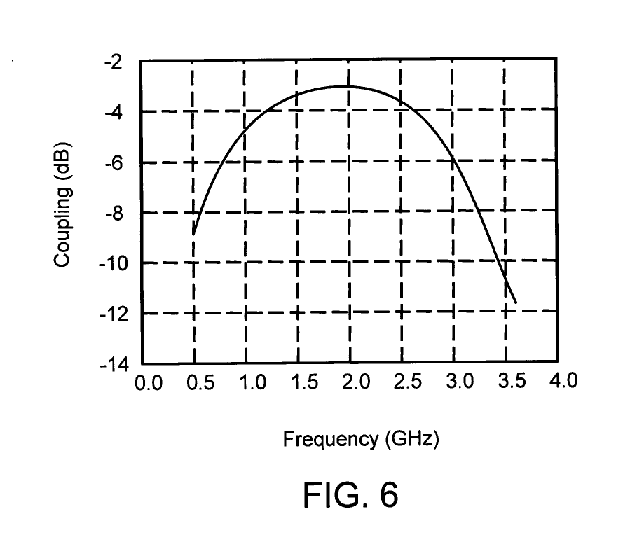

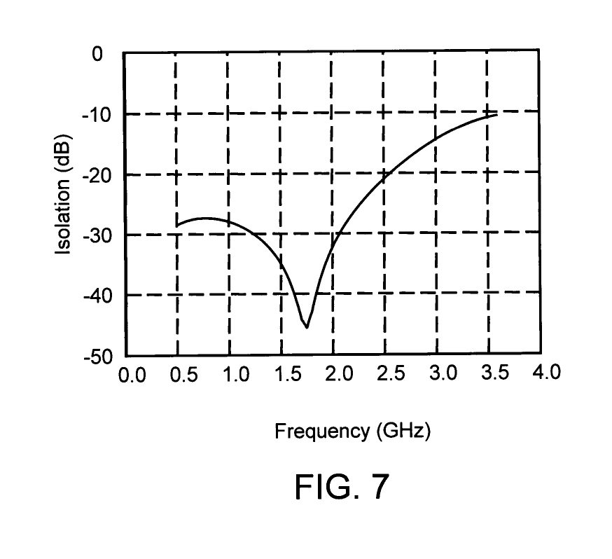

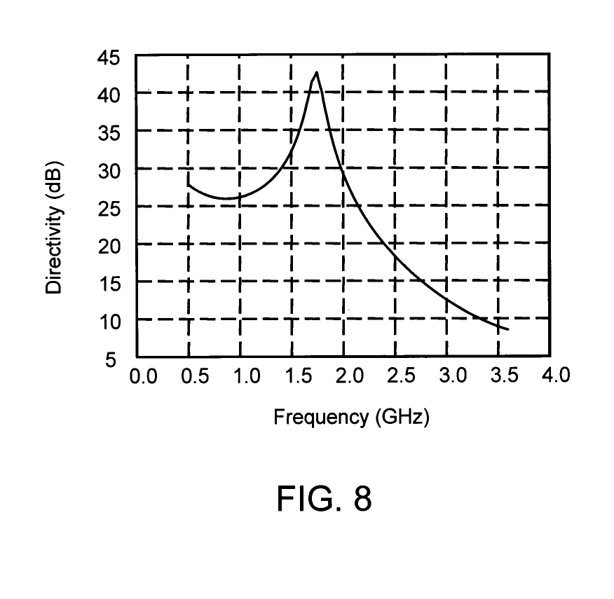

Simulations of the spurline directional coupler of the invention are shown in the following figures. FIG. 5 and FIG. 6 indicate the coupling amount. FIG. 7 indicates the isolation. FIG. 8 indicates the directivity. It can be seen that a zero is generated in the center frequency, where the coupling amount is maximal, and the directivity is maximized.

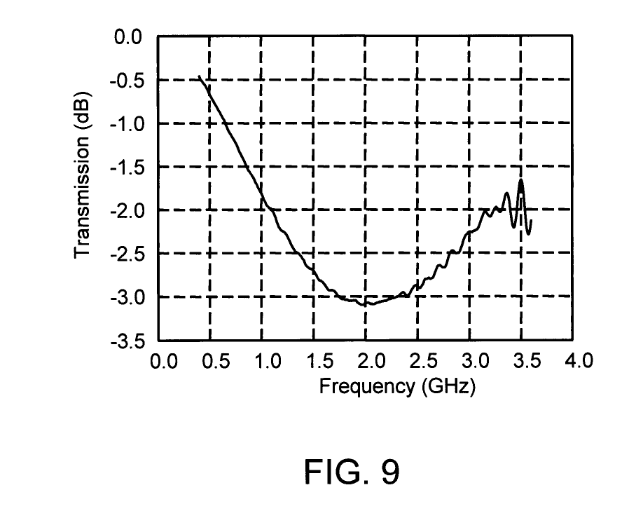

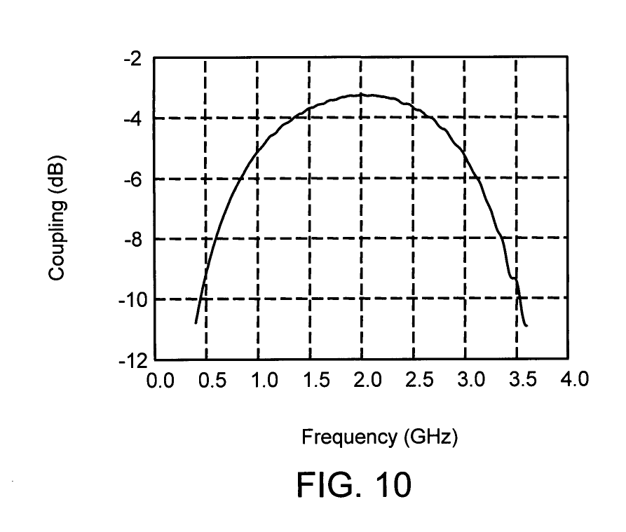

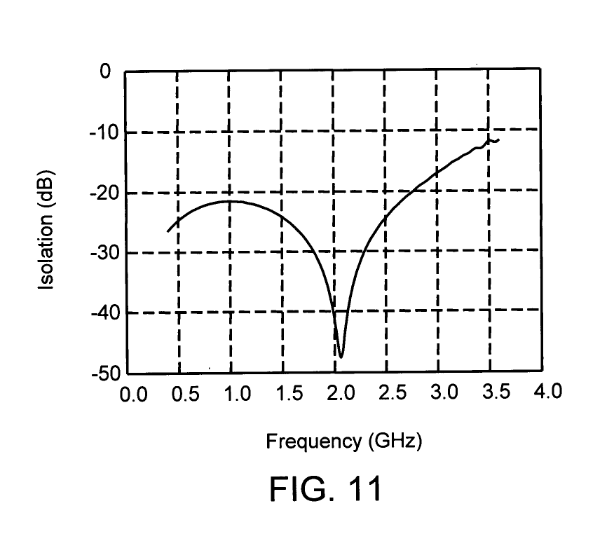

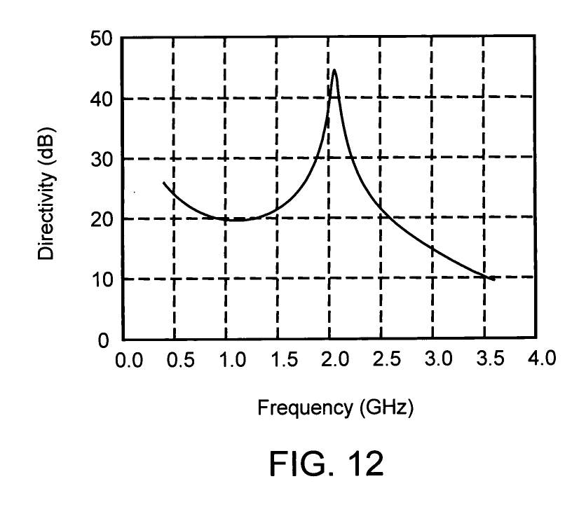

FIG. 9 indicates the measurement of the transmission amount. FIG. 10 indicates the measurement of the coupling amount. FIG. 11 indicates the measurement of isolation. FIG. 12 indicates the measurement of directivity. Compared with the simulation results, it can be seen that the measurement results of the structure of the invention agree very well with the simulation.

In summary, the spurline directional coupler uses the parallel coupling of the coupling section and the sub-coupling section to generate a capacitive effect to equalize the phase velocities of the even and odd modes, thereby generating isolation zero. Thus by controlling the length of the sub-coupling section, the frequency of the isolation zero may be controlled.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A spurline directional coupler, comprising:
a first coupling section having one end connected to a first signal transmission section and another end connected to a second signal transmission section;
a second coupling section having one end connected to a third signal transmission section and another end connected to a fourth signal transmission section, the second coupling section being substantially in parallel with the first coupling section for coupling;
a first sub-coupling section having one end connected to the first signal transmission section, and being substantially in parallel with the first coupling section to generate the capacitive effect therewith;
a second sub-coupling section having one end connected to the second signal transmission section and being substantially in parallel with the first coupling section to generate the capacitive effect therewith;
a third sub-coupling section having one end connected to the third signal transmission section and being substantially in parallel with the second coupling section to generate the capacitive effect therewith; and
a fourth sub-coupling section having one end connected to the fourth signal transmission section and being substantially in parallel with the second coupling section to generate the capacitive effect therewith.

2. The spurline directional coupler of claim 1, wherein the first coupling section, the first sub-coupling section, the second sub-coupling section, the first signal transmission section and the second signal transmission section are symmetrical to the second coupling section, the third sub-coupling section, the fourth sub-coupling section, the third signal transmission section and the fourth signal transmission section.

3. The spurline directional coupler of claim 1, wherein the first coupling section and the second coupling section are a TEM transmission line or a Quasi-TEM transmission line.

4. The spurline directional coupler of claim 1, wherein the first sub-coupling section and the second sub-coupling section are a TEM transmission line or a Quasi-TEM transmission line.

5. The spurline directional coupler of claim 1, wherein the third sub-coupling section and the fourth sub-coupling section are a TEM transmission line or a Quasi-TEM transmission line.

6. The spurline directional coupler of claim 1, wherein the first coupling section and the second coupling section are broadside-coupled in multilayer structure.

7. The spurline directional coupler of claim 1, wherein the first coupling section and the second coupling section are broadside-coupled in single layer structure.
